(19) United States
(12) Patent Application Publication
(10) Pub. No.: US 2016/0308570 A1
(43) Pub. Date: Oct. 20, 2016

(54) MOBILE ELECTRONIC DEVICE CASING

(71) Applicant: Sharp Kabushiki Kaisha, Osaka-shi (JP)

(72) Inventors: Ryohsuke Yamanaka, Osaka-shi (JP); Atsushi Fukui, Osaka-shi (JP); Satoshi Shibata, Osaka-shi (JP); Mehdi Shibahara, Osaka-shi (JP)

(21) Appl. No.: 15/130,606

(22) Filed: Apr. 15, 2016

(30) Foreign Application Priority Data
Apr. 15, 2015 (JP) 2015-083470

(51) Int. Cl. H04B 1/3883; H04W 52/02; H04M 1/02

(52) U.S. Cl. CPC H04B 1/3883; H04M 1/026; H04W 52/0296

(57) ABSTRACT

A mobile electronic device casing is provided. The casing accommodates a mobile electronic device having a display screen surface and supplies power to the device. The casing includes a solar cell module comprised of one or more cells and having a characteristic that in a case where a relationship between an illuminance and an open-circuit voltage is measured using a solar simulator under conditions that an air mass is 1.5, a solar cell module temperature is 25° C., and a light incident direction is perpendicular to each cell, when the illuminance is decreased from 100 mW/cm² to 1 mW/cm², a reduction amount of the open-circuit voltage is 0.2 V or less, and when the illuminance is 1 mW/cm², the open-circuit voltage is 0.55 V or more. The module is located on an opposite side from the display screen surface and exposed outside when the device is used while accommodated.

### BACKGROUND

The present invention relates to a mobile electronic device and a mobile electronic device casing.

Recently, chargers including a solar cell (hereinafter, referred to as “the solar cell module”) for charging a mobile electronic device typified by a smartphone are known, which may also be referred to as solar chargers. Such chargers typically include the solar cell module and a charging circuit for supplying power to a load or a rechargeable battery. For example, JP2012-060717A, JP2012-034448A, and JP2009-153372A disclose such chargers.

JP2009-060717A discloses a charger including a body casing for accommodating a mobile electronic device, a solar cell module attached to a back surface of the body casing to be exposed to an outside thereof, and a rechargeable battery for storing power from the solar cell module. With this charger, the mobile electronic device can easily be attached to the body casing, and thus, the mobile electronic device can be used in a state of being accommodated in the body casing. Further, by facing the back surface of the body casing to sunlight so that the solar cell module is irradiated by the sunlight, the solar cell module can generate power and feed it to the rechargeable battery.

JP2012-034448A discloses a foldable mobile electronic device including a solar cell module and a rechargeable battery provided to a housing of the device. The solar cell module is disposed in the housing so that the solar cell module is irradiated by sunlight in a folded state of the mobile electronic device. The mobile electronic device includes an ultraviolet ray sensor for detecting an illuminance of an ultraviolet ray. The mobile electronic device of JP2012-034448A controls whether to feed or not feed electronic power from the solar cell module to the rechargeable battery, according to the illuminance detected by the ultraviolet ray sensor. With the mobile electronic device, it can be suppressed that the solar cell module generates electronic power at a low conversion efficiency when an illuminance of sunlight is low.

JP2009-153372A discloses a charger including a dye-sensitized solar cell module and an adapter capable of external connection with a mobile electronic device. With the charger, an externally-connected mobile electronic device can be charged at a high conversion efficiency under an indoor light or sunlight outdoors.

However, since an amount of light irradiated to the solar cell module changes according to a situation where the charger or the mobile electronic device is used, an output voltage of the solar cell module varies. For example, between sunny weather and cloudy weather, the irradiation amount of light is greatly different and the output voltage greatly varies. Further, if the charger or the mobile electronic device inclines with respect to the irradiating direction of sunlight, an illuminance at a light receiving surface of the solar cell module changes and the output voltage may greatly vary.

Conventionally, in the field of solar cell modules, figuring out how to obtain a larger power generation amount within a limited installation area, has been considered important. Therefore, many discussions have been conducted about conversion efficiencies of the solar cell modules. For example, in “Outdoor Performances of Dye-sensitized Solar Cell” by K. Okada, H. Matsui, and N. Tanabe, published in Fujikura Technical Review No. 120, outdoor power generation performance of a dye-sensitized solar cell module is discussed in comparison to a conventional silicon solar cell module. However, it can be said a relationship between an illuminance and an output voltage of the solar cell module has not been focused upon until now.

The conversion efficiency of a solar cell module is calculated based on power obtained in a standard state defined by Japanese Industrial Standard (JIS C 8914), using a solar simulator (an air mass (AM): 1.5, an illuminance of pseudo-sunlight: 100 mW/cm², a solar cell module temperature: 25° C., a light incident direction: a direction perpendicular to a light receiving surface of a cell of the solar cell module). However, in Japan, the illuminance of 100 mW/cm² corresponds to an amount of light obtained at the time of the culmination of the summer solstice and such an illuminance is rarely obtainable. Moreover, it is also not often discussed much that a conversion efficiency of a charging circuit for supplying power to a load or a rechargeable battery decreases if the illuminance decreases. In particular, it can be said that a reduction of the output voltage of the solar cell module due to the illuminance decrease, which results in lowering the conversion efficiency of the charging circuit, has not been focused upon. The present inventors newly discovered issues that a variation of the output voltage due to a change of the illuminance affects the conversion efficiency of the charging circuit, and, specifically, that a dramatic reduction of an open-circuit voltage greatly affects the conversion efficiency of the charging circuit.

FIG. 1 illustrates illuminance dependencies of output voltages (open-circuit voltages) of solar cell modules. In FIG. 1, the horizontal axis is a logarithmic axis indicating an illuminance (mW/cm²), and the vertical axis indicates an open-circuit voltage Voc (V). FIG. 1 illustrates results of various solar cell modules, obtained through measurements using a solar simulator in a standard state defined by JIS. The measurement results of a polycrystalline silicon solar cell module (hereinafter, referred to as the “p-Si module”) is plotted with a diamond, the measurement results of a dye-sensitized solar cell module (hereinafter, referred to as the “DSC module”) is plotted with a square, and the measurement results of a low-illuminance-supported dye-sensitized solar cell module (hereinafter, referred to as the “low-illuminance-supported DSC module”) is plotted with a triangle. The low-illuminance-supported DSC module is described later in detail. Note that the output voltage of the DSC module disclosed in JP2009-153372A described above is plotted with a circle for reference.

Based on these results, it can be understood that the solar cell modules have a characteristic that the open-circuit voltage is reduced as the illuminance decreases regardless of their types. Moreover, when the illuminance decreases, the open-circuit voltages of the DSC module and the low-illuminance-supported DSC module are even higher than that of the p-Si module. Thus, the output voltage of the solar cell module greatly varies as the illuminance decreases. As a result, when directly charging with a charger a rechargeable battery built in a mobile electronic device, an issue may arise that the rechargeable battery cannot substantially be charged if the output voltage falls below, for example, a stand-by power of the mobile electronic device or a charging trigger on the mobile electronic device side (e.g., an operating voltage). Moreover, an issue may arise that the mobile electronic device cannot substantially be operated.

Due to the illuminance decrease, the conversion efficiency of a circuit inside the charger also degrades. As described later, the charger is provided with a control circuit (MPPT (Maximum Power Point Tracking) circuit) for controlling the output voltage of the solar cell module. If the output voltage falls below a rated input voltage of the control circuit, there is a possibility that the control circuit cannot be driven or cannot be operated appropriately. Further, if the illuminance is low, a change of the output voltage from the input voltage becomes extremely small and an operation accuracy of the control circuit degrades. A power consumption of the control circuit itself also cannot be ignored.

Chargers for charging a mobile electronic device are sold as products in which a solar cell module is provided to a main body of the device or a casing for accommodating the main body of the device. Further, as solar cell modules of such chargers, crystal silicon solar cell modules are mainly used. However, if the illuminance is low as illustrated in FIG. 1, an open-circuit voltage of the crystal silicon solar cell module is reduced, which means that the open-circuit voltage is dramatically reduced when an incident light intensity decreases. Therefore, it can be said that the power generation efficiency of the crystal silicon solar cell module in, for example, cloudy weather, is lower than those of other solar cell modules.

FIG. 2 is a view illustrating a state of a mobile electronic device being used by a user. Assuming that the user looks at a display screen surface of the mobile electronic device to control a main body of the device, it can be estimated that the main body normally inclines with respect to the vertical direction when operated as illustrated in FIG. 2. The inclination is approximately from 30° to 90° with respect to the vertical direction, for example. Here, a light receiving surface of the solar cell module at a back surface of the device also inclines approximately from 30° to 90° with respect to the vertical direction, and thus, the illuminance of sunlight at the light receiving surface decreases. Note that the slashed area in FIG. 2 indicates an area where direct sunlight does not reach since it is blocked by the main body of the device.

As illustrated in FIG. 2, in the state where the mobile electronic device inclines, the light receiving surface of the solar cell module may receive scattered light and a reflection of sunlight. Note that illuminance of the scattered light and the reflection of sunlight are lower than that of direct sunlight. Here, a situation where reflection of sunlight on a ground surface enters the light receiving surface of the solar cell module obliquely (not perpendicularly) in the state where the mobile electronic device inclines is considered for example. In this case, an illuminance of the incident light decreases even lower. As a result, since the light receiving surface of the solar cell module inclines, the output voltage may dramatically drop. Thus, in the state of FIG. 2, the illuminance becomes low, the charger including the conventional solar cell module (e.g., p-Si module) and the charging circuit does not generate power in the first place, and thus, power cannot be obtained. Therefore, with the conventional charger, power generation cannot efficiently be performed while controlling the mobile electronic device.

### SUMMARY

The present invention aims to efficiently generate power while controlling a mobile electronic device even when an illuminance is decreased and an output voltage of a solar cell module is reduced.

According to one aspect of the present invention, a mobile electronic device casing for accommodating a mobile electronic device having a display screen surface, and supplying power to the mobile electronic device, is provided. The mobile electronic device casing includes a solar cell module comprised of one or more cells and having a characteristic that in a case where a relationship between an illuminance and an open-circuit voltage is measured by using a solar simulator under a condition that an air mass is 1.5, a temperature of the solar cell module is 25° C., and a light incident direction is perpendicular to a light receiving surface of the cell, when the illuminance is decreased from 100 mW/cm² to 1 mW/cm², a reduction amount of the open-circuit voltage is 0.2 V or less, and when the illuminance is 1 mW/cm², the open-circuit voltage is 0.55 V or more. The solar cell module is located on an opposite side from the display screen surface and exposed to an outside of the mobile electronic device casing when the mobile electronic device is used in the accommodated state. From a viewpoint of a conversion efficiency of a charging circuit etc., the reduction amount of the open-circuit voltage is preferably 0.15 V or less.

The solar cell module preferably has a structure in which the cells are electrically-linearly connected with each other and the cells are integrated on a single substrate.

The mobile electronic device casing preferably further includes a power supply unit for supplying the power from the solar cell module to a load. The power supply unit preferably includes a voltage regulator having one of a step-up converter and a step-down converter.

The voltage regulator preferably also includes a control circuit for performing a control of tracking an optimal operating point of the solar cell module.

The solar cell module is preferably one of a dye-sensitized solar cell module and a solar cell module using a fluorescence condensing plate.

According to the aspect of the present invention, a mobile electronic device and a mobile electronic device casing are provided, which can efficiently generate power while controlling the mobile electronic device even when an illuminance is decreased and an output voltage of a solar cell module is reduced.

### BRIEF DESCRIPTION OF THE DRAWINGS

FIG. 1 is a chart illustrating illuminance dependencies of output voltages of solar cells.

FIG. 2 is a view illustrating a state of a mobile electronic device being used by a user.

FIG. 3 is a front view of a mobile electronic device casing 200A accommodating a mobile electronic device 300 according to a first embodiment of the present invention.

FIG. 4 is a rear view of the mobile electronic device casing 200A according to the first embodiment.

FIG. 5 is a schematic view illustrating a cross-sectional structure of a DSC 100 used in a low-illuminance-supported DSC module 400 according to the first embodiment.

FIG. 6 is a schematic view illustrating a cross-sectional structure of the low-illuminance-supported DSC module 400 having a plurality of DSCs 100a according to the first embodiment.

FIG. 7 is a schematic view illustrating a circuit configuration of the mobile electronic device casing 200A according to the first embodiment.

FIGS. 8A and 8B show schematic views illustrating circuit configurations of a power supply unit 230A according to the first embodiment.

FIG. 9 is a schematic view illustrating a circuit configuration of a mobile electronic device casing 200B according to a second embodiment of the present invention.

FIG. 10 is schematic view illustrating a circuit configuration of a resistance unit 250 according to the second embodiment.

FIG. 11 is a schematic view illustrating a circuit configuration of a mobile electronic device casing 200C according to a third embodiment of the present invention.

FIGS. 12A and 12B are schematic views illustrating a structure of a fluorescence-plate condensing solar cell module 500 according to a fourth embodiment of the present invention.

FIG. 13 is a chart illustrating an illuminance dependency of an output voltage of the fluorescence-plate condensing solar cell module 500 according to the fourth embodiment.

### DETAILED DESCRIPTION OF EMBODIMENTS

Mobile electronic device casings according to embodiments of the present invention accommodate a mobile electronic device having a display screen surface, and supply power to the mobile electronic device. Each mobile electronic device casing includes a solar cell module comprised of one or more cells and having a characteristic that in a case where a relationship between an illuminance and an open-circuit voltage is measured by using a solar simulator under a condition that an air mass (AM) is 1.5, a solar cell module temperature is 25° C., and a light incident direction is perpendicular to a light receiving surface of the cell, when an illuminance decreases from 100 mW/cm² to 1 mW/cm², a reduction amount of an open-circuit voltage is 0.2 V or less, and when the illuminance is 1 mW/cm², the open-circuit voltage is 0.55 V or more. The solar cell module is located on an opposite side from the display screen surface and exposed to an outside of the mobile electronic device casing when the mobile electronic device is used in the accommodated state. According to the mobile electronic device casings, power generation can efficiently be performed while controlling the mobile electronic device. Examples of the mobile electronic device include a digital book terminal device, a mobile phone, a smartphone, and a tablet PC.

Hereinafter, the mobile electronic device casings according to the embodiments of the present invention are described with reference to the appended drawings. In the following description, same or similar components are denoted with the same reference characters. Note that the mobile electronic device casings according to the embodiments of the present invention are not to be limited to those given below as examples. One embodiment may be combined with another embodiment, for example.

### First Embodiment

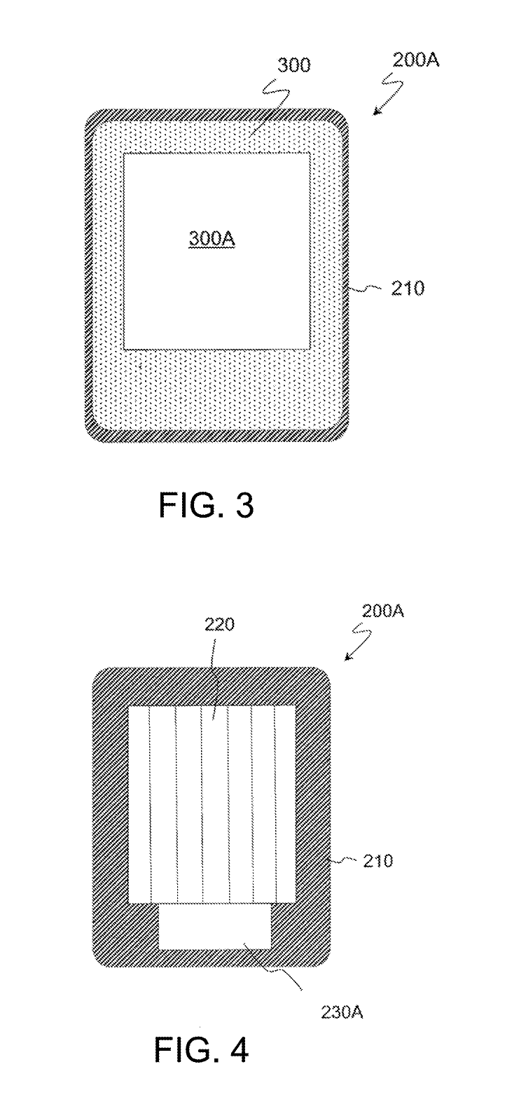

A circuit configuration and functions of a mobile electronic device casing 200A according to a first embodiment is described with reference to FIGS. 3 to 7.

FIG. 3 is a front view of the mobile electronic device casing 200A accommodating a mobile electronic device 300. FIG. 4 is a rear view of the mobile electronic device casing 200A. The mobile electronic device casing 200A of this embodiment includes a holder part 210, a solar cell module 220, and a power supply unit 230A. The mobile electronic device casing 200A accommodates the mobile electronic device 300 and is capable of supplying power to the mobile electronic device 300. The mobile electronic device casing 200A also functions as a charger.

As illustrated in FIGS. 3 and 4, the mobile electronic device 300 is electrically and directly connected with the mobile electronic device casing 200A via a connector (not illustrated) and integrated therewith. In this state, power generated by the solar cell module 220 can be supplied to the mobile electronic device 300. Specifically, the solar cell module 220 is connected at its output side with a power storage element of the mobile electronic device 300 at its input side. Here, the power storage element includes a so-called rechargeable battery (secondary battery) and also a large-volume capacitor. When the mobile electronic device casing 200A is integrally used with the mobile electronic device 300, the mobile electronic device 300 does not necessarily have the power storage element.

The holder part 210 has space for accommodating the mobile electronic device 300 having a display screen surface 300A in its front surface, and is capable of holding the mobile electronic device 300. The mobile electronic device 300 is easily removable from the holder part 210. Further, also in the state where the mobile electronic device 300 is removed, the mobile electronic device casing 200A may function as a charger.

The solar cell module 220 is disposed at a back surface of the mobile electronic device casing 200A. Specifically, when the mobile electronic device 300 is used in the state accommodated in the holder part 210, the solar cell module 220 is located at the back surface side, which is an opposite side from the display screen surface 300A, and is exposed to an outside of the mobile electronic device casing 200A. According to this structure, an area of a light receiving surface of the solar cell module 220 can be increased by disposing the solar cell module 220 to cover substantially the entire back surface of the mobile electronic device casing 200A. As a result, compared to a solar cell module mounted on, for example, an electronic calculator, the power generation amount can dramatically be increased.

The mobile electronic device casing 200A of this embodiment is not limited to the mode illustrated in FIGS. 3 and 4. For example, when the mobile electronic device 300 is not in use, the surface of the casing 200A where the solar cell module 220 is provided may function as a cover for protecting the display screen surface 300A.

As the solar cell module 220, a low-illuminance-supported solar cell module may be used. In the present specification, the low-illuminance-supported solar cell module means a solar cell module of which a reduction amount of an open-circuit voltage is small even when the illuminance decreases. Hereinafter, characteristics of the low-illuminance-supported solar cell module are described in detail.

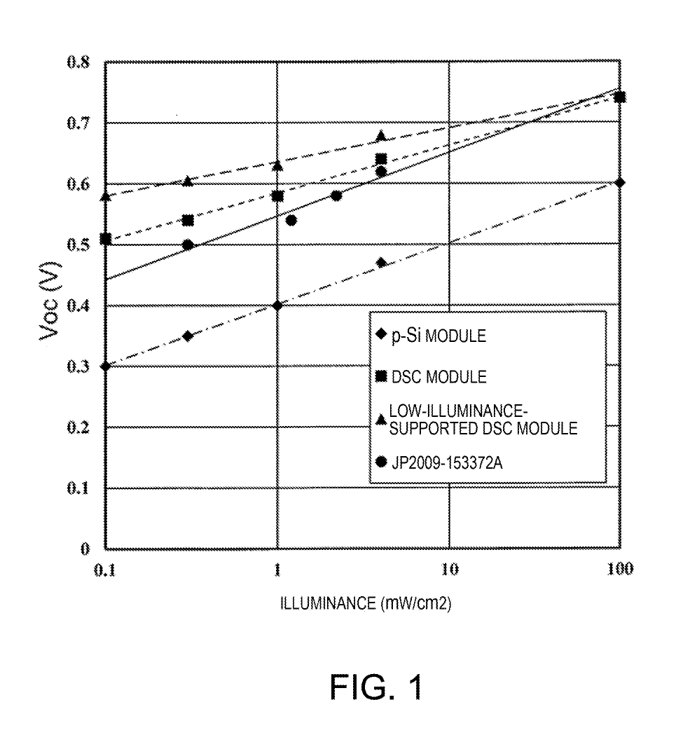

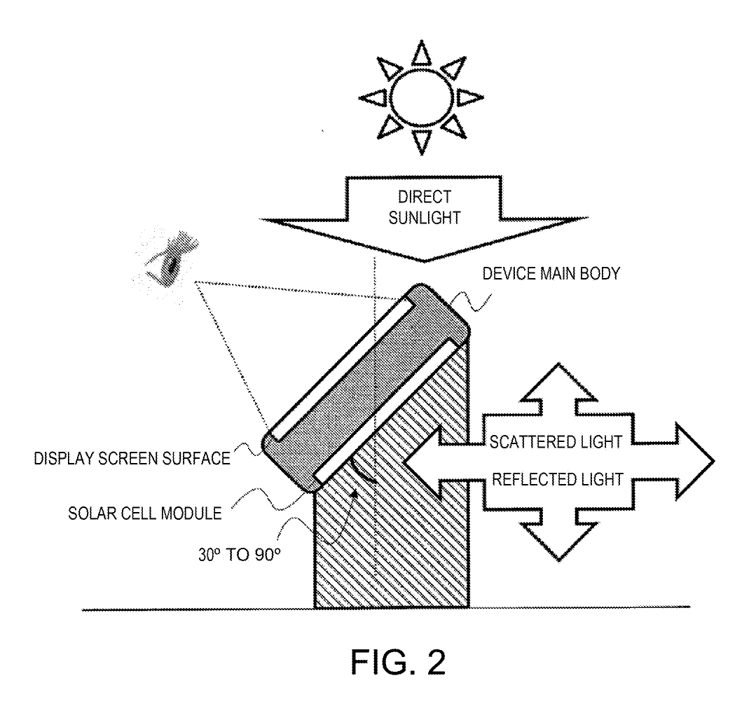

Returning to FIG. 1, in a case where the illuminance is comparatively low, in the conventional crystal silicon solar cell module, in terms of a relationship between the illuminance and the open-circuit voltage, when the illuminance changes from 100 mW/cm² to 0.1 mW/cm², a largest output voltage (open-circuit voltage) varies from 0.60 V to 0.30 V per unit cell. In other words, it can be understood that a variation amount AV per unit cell of the conventional crystal silicon solar cell module is 0.30 V. On the other hand, with the same amount of change in illuminance, a largest output voltage of the DSC module varies from 0.75 V to 0.50 V per unit cell. In other words, it can be understood that a variation amount AV per unit cell of the DSC module is 0.25 V. Based on this result, it can also be understood that the DSC module with the smaller variation amount ΔV per unit cell is preferably used as the low-illuminance-supported solar cell module.

Further, the low-illuminance-supported solar cell module has a characteristic that in a case where the illuminance is comparatively high, in terms of a relationship between the illuminance and the open-circuit voltage, when the illuminance changes from 100 mW/cm² to 1 mW/cm², the reduction amount of the open-circuit voltage is 0.20 V or less. From a viewpoint of a conversion efficiency of the charging circuit, etc., the voltage reduction amount is preferably 0.15 V or less. Moreover, when the illuminance is 1 mW/cm², the open-circuit voltage of the low-illuminance-supported solar cell module is 0.55 V or more, which is higher than that of the p-Si module. By such characteristics, the power generation can be performed efficiently even in the case where the illuminance is comparatively high (e.g., when irradiated by direct sunlight outdoors).

In this embodiment, a low-illuminance-supported DSC module 400 (see FIG. 6) may be used as the solar cell module 220. An illuminance dependency of an output voltage (open-circuit voltage) of the low-illuminance-supported DSC module 400 is as illustrated in FIG. 1. Specifically, under a measurement condition defined by the standard JIS C 8914, in terms of a relationship between the illuminance and the open-circuit voltage, when the illuminance changes from 100 mW/cm² to 1 mW/cm², a largest output voltage (open-circuit voltage) varies from 0.73 V to 0.63 V per unit cell of the low-illuminance-supported DSC module 400. In other words, the variation amount ΔV per unit cell is improved to 0.10V, which is even smaller than that of the conventional DSC module. Further, the open-circuit voltage when the illuminance is 1 mW/cm² is 0.60 V or more, which is the highest among the four kinds of modules listed in FIG. 1. Based on this result, it can be said that the low-illuminance-supported DSC module 400 with the smallest variation amount ΔV per unit cell is particularly preferably used as the low-illuminance-supported solar cell module.

The solar cell module 220 may have a structure in which a plurality of cells are electrically-linearly connected with each other and integrated on a single substrate. For example, FIG. 4 illustrates a state where a plurality of cells are integrated in a stripe pattern (stripe-pattern integrated solar cell module). The structure of the stripe-pattern integrated solar cell module is seen in many DSC modules, and this structure may be adopted to the low-illuminance-supported DSC module 400 of this embodiment.

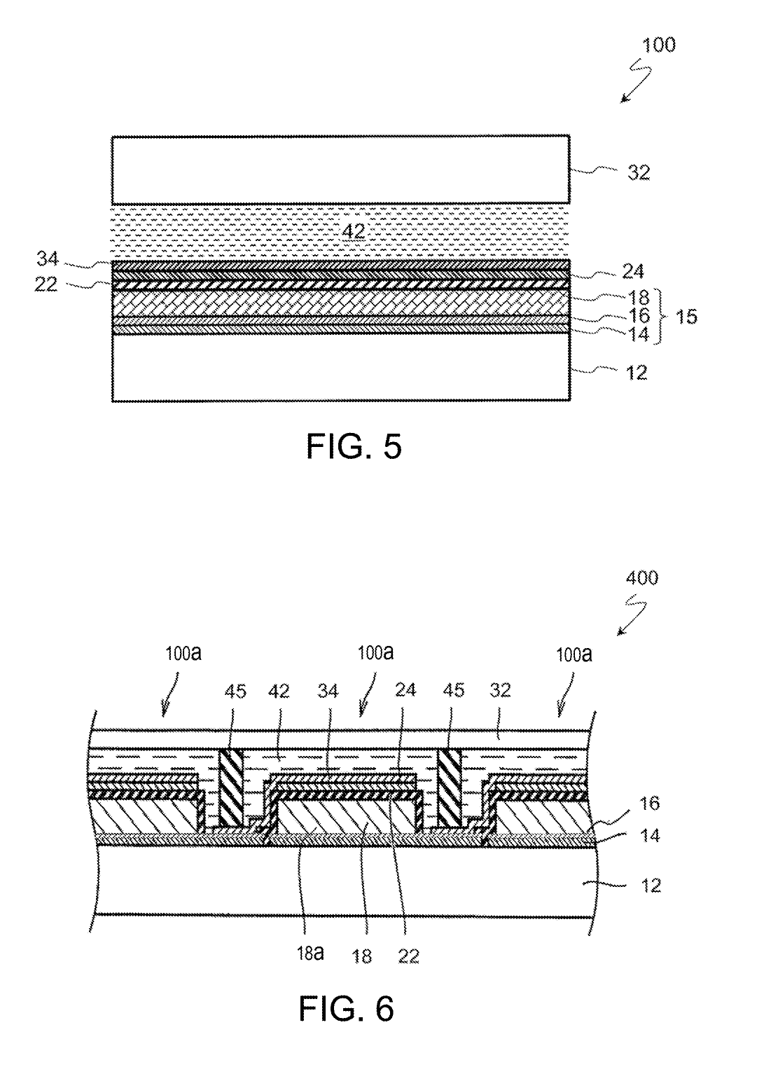

Hereinafter, one example of a structure of the low-illuminance-supported DSC module 400 is described with reference to FIGS. 5 and 6.

FIG. 5 schematically illustrates a cross-sectional structure of a DSC 100 used in the low-illuminance-supported DSC module 400 according to this embodiment. FIG. 6 schematically illustrates a cross-sectional structure of the low-illuminance-supported DSC module 400 having a plurality of DSCs 100a, which are a plurality of DSCs 100 that have been electrically-linearly connected with each other.

As illustrated in FIG. 5, each DSC 100 has a transparent substrate 12, a photoanode 15 formed on the transparent substrate 12, a porous insulating layer 22 formed on the photoanode 15, an antipole 34 formed on the porous insulating layer 22, a catalyst layer 24, a substrate 32, and an electrolytic medium 42 filled between the photoanode 15 and the substrate 32. The electrolytic medium 42 typically is an electrolyte solution. The electrolyte solution contains at least I⁻ and I₃⁻ as a mediator (redox pair). The electrolytic medium 42 enters into the porous insulating layer 22 provided between the photoanode 15 and the antipole 34. The electrolytic medium 42 held by the porous insulating layer 22 functions as a carrier transport layer. In a case where a structure in which the antipole 34 is formed on the substrate 32 so that the photoanode 15 is not physically in contact with the antipole 34 in an environment of using the DSC is adopted, the porous insulating layer 22 may be omitted.

However, by adopting the structure of FIG. 5 in which the components described above, from the photoanode 15 to the antipole 34, are formed on the transparent substrate 12 (i.e., monolithically-integrated structure), for example, a glass plate which is comparatively thin in thickness and low in cost can be used as the substrate 32. Such a substrate 32 (thinner than the substrate 12) may also be referred to as a cover member. By adopting the monolithically-integrated structure, only one glass substrate having an FTO (Fluorine doped Tin Oxide) layer (as the transparent substrate 12 and a transparent conductive layer 14), which is relatively expensive, is required, and thus, it is advantageous in reducing the cost of the DSC module.

As the transparent substrate 12 and the substrate 32, known transparent substrates, such as glass substrates or plastic substrates, may be adopted. Here, light is received from the transparent substrate 12 side, and therefore, at least the type of the substrate as the transparent substrate 12 is selected so that light having a wavelength with which a photosensitizer of the DSC 100 is excited is sufficiently transmitted through the transparent substrate 12. The substrate 32 may be transparent or nontransparent. However, when used in an environment in which light enters also from the substrate 32 side, the substrate 32 is preferably transparent, so as to increase an amount of light reaching the photosensitizer.

The photoanode 15 of the DSC 100 includes the transparent conductive layer 14 provided on the electrolytic medium 42 side of the substrate 12, a metallic oxide layer 16 formed on the electrolytic medium 42 side of the transparent conductive layer 14, a porous semiconductor layer 18 provided on the electrolytic medium 42 side of the metallic oxide layer 16, and a sensitizing dye (not illustrated) carried by the porous semiconductor layer 18. Note that the porous semiconductor layer carrying the sensitizing dye may be referred to as the photoelectric conversion layer 18. The transparent conductive layer 14 is made of a Transparent Conductive Oxide (TCO), such as FTO.

The antipole 34 collects electrons by coming into contact with the catalyst layer 24 having a function of reducing positive holes within the carrier transport layer 42, and is connected with an extraction electrode (the transparent conductive layer 14 electrically insulated from the photoelectric conversion layer 18 opposing thereto, not illustrated) and/or one of the transparent conductive layer 14 and the metallic oxide layer 16 of an adjacent DSC of the corresponding DSC. Examples of the materials of the antipole 34 include conductive materials including metallic materials, such as metallic oxides, titanium, tungsten, gold, silver, copper, and nickel, which are generally used for solar cells. Examples of the metallic oxides include FTO, Indium Tin Oxide (ITO), and Zinc Oxide (ZnO). Note that in the DSC module having the monolithically-integrated structure applied to the DSC module 400 illustrated in FIG. 6, titanium is preferably used from a viewpoint of a film strength of the antipole 34.

Here, an electric resistance of the metallic oxide layer 16 is lower than that of the porous semiconductor layer 18 but higher than that of the transparent conductive layer 14. By such an electric resistance of the metallic oxide layer 16, generation of a leakage current caused by direct contact between I₃⁻ within the electrolytic medium 42 and the transparent conductive layer 14 can be suppressed and an excessive reduction of an output current of the DSC 100 can be suppressed. As a result, the DSC 100 becomes capable of maintaining a comparatively high open-circuit voltage even when the illuminance is low, and thus, the DSC 100 can output power within a comparatively wide illuminance range. The metallic oxide layer 16 is preferably a nonporous layer. The thickness of the metallic oxide layer 16 does not exceed 10 nm, for example. The metallic oxide layer 16 is a thermal oxide film, for example. The metallic oxide layer 16 is further a titanium oxide layer, a zirconium oxide layer, or an aluminum oxide layer, for example. Among these layers, the titanium oxide layer is preferable. By forming the titanium oxide layer by thermal oxidation, no pinhole is formed and the generation of the leakage current can effectively be suppressed. Further, unless the thickness of the metallic oxide layer 16 exceeds 10 nm, sufficient output power can be obtained. The thickness of the metallic oxide layer 16 is preferably 1 nm or more, for example.

The metallic oxide layer 16 is preferably formed by a heat treatment (burning) in an environment with oxygen, on a titanium layer formed on the transparent conductive layer 14 by a thin-film deposition method, such as a vapor deposition method or sputtering. For example, a titanium layer of 2 nm thickness is formed on a substrate surface having an FTO layer, by using a sputtering device (type: CSS-2MT-1200R) manufactured by Shincron Co., Ltd. (e.g., target power: 1,100W, Ar flow rate: 120 sccm, and conveying speed: 100 mm/s). Then, for example, the titanium layer is kept at 500° C. for one hour for thermal oxidization. Thus, a titanium oxide layer having a thickness of 2 nm can be obtained. An increase in thickness due to the oxidation of the titanium layer is only a few %.

The metallic oxide layer 16 can also obtain such a titanium oxide layer by a surface treatment on a surface of the transparent conductive layer 14 with a water solution of titanium tetrachloride (TiCl₄), gas containing titanium tetrachloride, etc., and then burning the treated surface. For example, a titanium tetrachloride water solution of 0.05M is dropped on a substrate surface having an FTO layer and then the substrate surface is heat-treated at 70° C. for approximately 20 minutes. Next, the heat-treated surface is washed, naturally dried, and then kept at 500° C. for one hour for thermal oxidization. Thus, a titanium oxide layer of 2 nm thickness can be obtained. Note that the titanium tetrachloride water solution may be applied to the substrate surface having the FTO layer by a known method other than the falling-drop method, such as a spin coating method or a dip method.

The electrolytic medium 42 is preferably an electrolyte solution (e.g., water solution) containing I⁻ and I₃⁻. A concentration of I₃⁻ is preferably above 0.02 M but 0.05 M or less. By such a range of the concentration of I₃⁻, a voltage reduction is suppressed and power can efficiently be generated over a range from low to high illuminances. Examples of a solvent of the electrolyte solution include carbonate series solvents (e.g., propylene carbonate), nitrile series solvents (e.g., acetonitrile), and alcohol series solvents (e.g., ethanol). Among these solvents, the carbonate series solvents or the nitrile series solvents are preferable. Two or more kinds of the solvents described above may be used in combination. Note that from a viewpoint of power generation characteristics, nitrile series solvents are more preferable. The solvent is selected comprehensively from viewpoints of a solvent viscosity, solubility of electrolytes, etc., according to a temperature environment in which the DSC is installed.

Next, a structure of the low-illuminance-supported DSC module 400 which is used for the solar charger according to this embodiment is described with reference to FIG. 6. The DSCs 100 are electrically-linearly connected with each other according to a required output voltage, and is used as a module. In FIG. 6, components having substantially the same functions as those illustrated in FIG. 5 are denoted with the same reference characters and descriptions thereof may be omitted.

The low-illuminance-supported DSC module 400 illustrated in FIG. 6 includes the plurality of DSCs 100a electrically-linearly connected with each other and packaged as a whole. The plurality of DSCs 100a share a transparent substrate 12. Electrolytic mediums (carrier transport layer) 42 of each DSC 100a are separated from each other by a sealing member 45 and sealed thereby. The low-illuminance-supported DSC module 400 is also entirely sealed by a sealing member that fixedly adheres the transparent substrate 12 to a substrate 32.

On the transparent substrate 12 of each DSC 100a, a transparent conductive layer 14, a metallic oxide layer 16, and a photoelectric conversion layer 18 including a porous semiconductor layer 18a are formed in this order. The photoelectric conversion layer 18 is covered by a porous insulating layer 22 on which an antipole 34 is formed intervening a catalyst layer 24 therebetween. The antipole 34 extends to a position on the metallic oxide layer 16 of an adjacent DSC 100a and, thus, is electrically-linearly connected with the adjacent DSC 100a. Note that the metallic oxide layer 16 may be formed so that the sealing member 45 comes into direct contact with the transparent conductive layer 14.

The number of the DSCs 100a electrically-linearly connected in the low-illuminance-supported DSC module 400 is suitably set according to a required output voltage. For example, when the number is seven, approximately 3.5 V of output voltage can be obtained. The low-illuminance-supported DSC module 400 may be manufactured by a known method except for the metallic oxide layer 16. For example, the method disclosed in WO2014/038570A1 may be applied in the manufacturing.

Each of the DSCs provided to the mobile electronic device casing 200A of this embodiment has the metallic oxide layer 16 having an electric resistance lower than that of the porous semiconductor layer 18a but higher than that of the transparent conductive layer 14, as described above regarding the DSC 100. As a result, the DSC 100 can supply power to the mobile electronic device at a sufficiently high output voltage over a wide range from low to high illuminances.

Returning to FIG. 4, the back surface of the mobile electronic device casing 200A is provided with the power supply unit 230A. The mobile electronic device 300 is electrically connected with the solar cell module 220 via the power supply unit 230A, and the power supply unit 230A feeds the power from the solar cell module 220 to the mobile electronic device 300. Note that the power supply unit 230A may not be disposed to be exposed to the outside as illustrated in FIG. 4, and it may obviously be disposed inside the mobile electronic device casing 200A so that it is not visible from the outside.

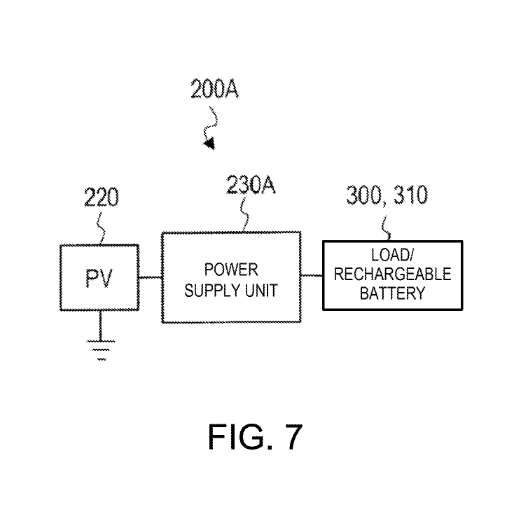

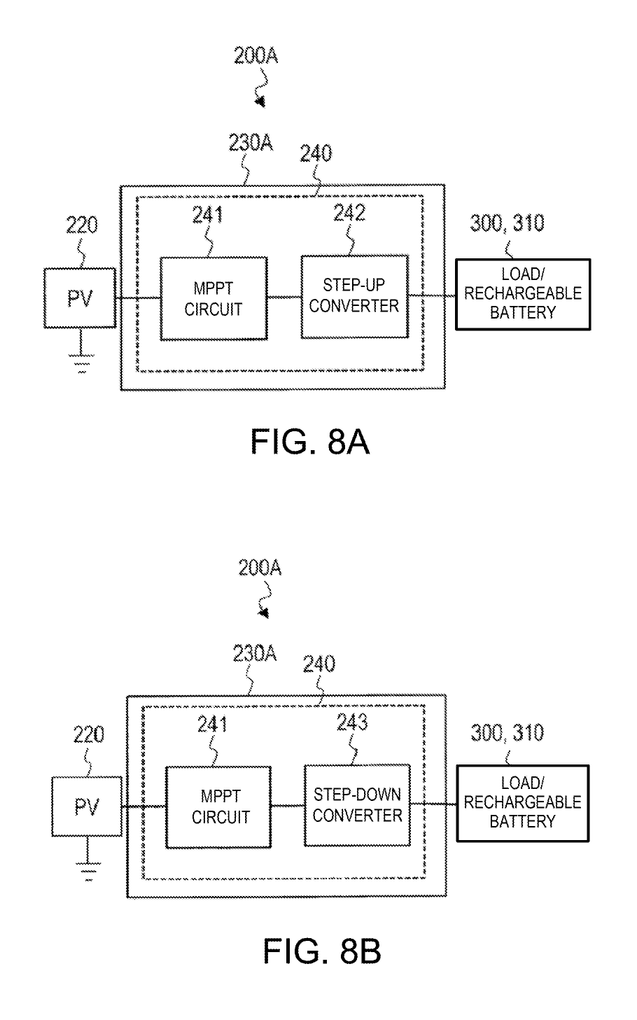

Next, a structure and functions of the power supply unit 230A are described in detail with reference to FIGS. 7, 8A, and 8B.

FIG. 7 schematically illustrates a circuit configuration of the mobile electronic device casing 200A. The mobile electronic device 300 (i.e., a load) is electrically connected with the solar cell module 220 via the power supply unit 230A. In FIG. 7, the solar cell module 220 is denoted with “PV.” As illustrated in FIG. 7, the power supply unit 230A may be connected with a rechargeable battery 310 provided to the mobile electronic device casing 200A, instead of being directly connected with the mobile electronic device 300. In this case, the rechargeable battery 310 may be charged before supplying the power accumulated in the rechargeable battery 310 to the mobile electronic device 300. As the rechargeable battery 310, for example, a lithium-ion rechargeable battery, a lithium-ion polymer rechargeable battery, or a nickel-hydrogen battery may be used.

FIGS. 8A and 8B schematically illustrate circuit configurations of the power supply unit 230A. As illustrated in FIGS. 8A and 8B, the power supply unit 230A includes a control circuit such as an MPPT circuit 241 and a voltage regulator 240. The voltage regulator 240 has one of a step-up converter 242 and a step-down converter 243.

The MPPT circuit 241 performs a control of tracking an optimal operating point of the solar cell module 220. The optimal operating point indicates an operating point at which output power (a product of a current and a voltage) of the solar cell module 220 reaches its maximum value. By using the MPPT circuit 241, even when the illuminance and/or the temperature change, the solar cell module 220 can generate power at the optimal operating point under the corresponding circumstance, and the greatest power possible in that circumstance can be obtained. Any of various known circuits may broadly be used as the MPPT circuit 241.

The step-up converter 242 increases the output voltage of the solar cell module 220. Specifically, when a sufficient voltage to feed the power to one of the rechargeable battery 310 and the load 300 cannot be obtained, the step-up converter 242 increases the output voltage of the solar cell module 220 to a voltage level at which the power can be fed to the one of the rechargeable battery 310 and the load 300. For example, a DC-DC converter may be used as the step-up converter 242.

The step-down converter 243 reduces the output voltage of the solar cell module 220. Specifically, when the voltage is excessively high when feeding the power to one of the rechargeable battery 310 and the load 300, the step-down converter 243 reduces the output voltage of the solar cell module 220 to a voltage level suitable for an input voltage of the one of the rechargeable battery 310 and the load 300. For example, a DC-DC converter may be used as the step-down converter 243. Whether to mount the step-up converter 242 or the step-down converter 243 on the voltage regulator 240 may suitably be determined based on a product specification, etc.

As described above, by connecting one of the load 300 and the rechargeable battery 310 with the voltage regulator 240, even if the illuminance decreases and the output voltage of the solar cell module 220 is dramatically varied, the power from the solar cell module 220 can stably be supplied to the one of the load 300 and the rechargeable battery 310. Further, the mobile electronic device 300 can be stably operated as a load.

According to this embodiment, the area of the solar cell module 220 can be increased. As a result, the power generation amount of the solar cell module 220 can dramatically be increased. Further, by using the low-illuminance-supported solar cell module, even in an environment that the light receiving surface is not irradiated by direct sunlight and the illuminance is significantly low, the charging can be performed effectively while using the mobile electronic device 300. Moreover, the power generation can also be efficiently performed also when the illuminance is high. Note that in order to perform the charging rapidly, in the state where the mobile electronic device 300 is removed from the mobile electronic device casing 200A, the mobile electronic device casing 200A may be placed, for example, near a window so that the light receiving surface of the solar cell module 300 faces an outdoor side.

For example, for the purpose of reducing the area of the solar cell module 220 to avoid the solar cell module 220 from being caught by a hand of the user holding the casing, a case of disposing the solar cell module 220 in one of a range of the front surface of the mobile electronic device 300 other than the range where the display screen surface 300A is disposed and part of the back surface of the mobile electronic device casing 200A, is considered. In this case, the solar cell module 220 is eccentrically located in part of the front surface or the back surface, and thus, a center of gravity of the solar cell module 220 is also eccentric, which places an extra burden on the user who controls the mobile electronic device 300 while holding it. However, according to this embodiment, since the area of the solar cell module 220 can be larger than the display screen surface 300A, the eccentricity of the center of gravity can be eliminated.

In the case of constructing the solar cell module 220 by integrating a plurality of cells, there is a possibility of dramatically reducing the output current of the solar cell module 220 depending on the direction in which the cells are electrically-linearly connected. This is because, in the structure in which a plurality of cells are electrically-linearly connected, if even one of the plurality of cells is entirely covered by the hand of the user, the covered cell does not generate power and the current does not flow therethrough, resulting in a dramatic reduction of the output current. According to this embodiment, as illustrated in FIG. 4, each cell may be arranged such that its longitudinal direction is substantially parallel to a longitudinal direction of the mobile electronic device casing 200A. Since the user generally holds the casing in a manner that extending directions of the fingers of their hand substantially perpendicularly intersect with the longitudinal direction of the mobile electronic device casing 200A, by the above arrangement, the longitudinal direction of each cell substantially perpendicularly intersects with the extending directions of the fingers of the hand holding the casing. Therefore, complete coverage of the cell can be avoided, and power reduction can be suppressed.

The present inventors prototyped two mobile electronic device casings 200A of this embodiment. As the solar cell module, one of the prototyped casings included a p-Si module and the other casing included a DSC module. A situation where the charging is performed while the user holds the casing by his/her hand and controls the mobile electronic device 300 was considered. A power generation amount of the solar cell module was measured with each prototype without the voltage regulator 240.

The power generation amount in one hour was measured at illuminances of 0.2 mW/cm² and 20 mW/cm². With the p-Si module, the power generation amount in one hour at the illuminance of 0.2 mW/cm² was 0.006 mWh/cm² and the power generation amount in one hour at the illuminance of 20 mW/cm² was 1.400 mWh/cm². On the other hand, with the DSC module, the power generation amount in one hour at the illuminance of 0.2 mW/cm² was 0.240 mWh/cm² and the power generation amount in one hour at the illuminance of 20 mW/cm² was 2.000 mWh/cm². Also based on this measurement result, it was found that at any illuminance, the power generation amount when the casing is held by the hand of the user and the mobile electronic device 300 is charged while being controlled is larger in the DSC module.

Moreover, in order to measure effects of the voltage regulator 240, the present inventors prepared a casing with the voltage regulator 240 and a casing without the voltage regulator 240 and measured the power generation amount of the solar cell module for each prototype, considering a situation where the charging is performed while a user holds the casing with their hand and controls the mobile electronic device 300. Note that the p-Si module was used for the solar cell modules 220 of both of the prototypes.

Also in this experiment, the power generation amount in one hour was measured at illuminances of 0.2 mW/cm² and 20 mW/cm². Without the voltage regulator 240, the power generation amount in one hour at the illuminance of 0.2 mW/cm² was 0.006 mWh/cm² and the power generation amount in one hour at the illuminance of 20 mW/cm² was 1.400 mWh/cm². On the other hand, with the voltage regulator 240, the power generation amount in one hour at the illuminance of 0.2 mW/cm² was 0.008 mWh/cm² and the power generation amount in one hour at the illuminance of 20 mW/cm² was 1.600 mWh/cm². Based on this measurement result, it was found that the voltage regulator 240 increases the power generation amount of the solar cell module 220.

### Second Embodiment

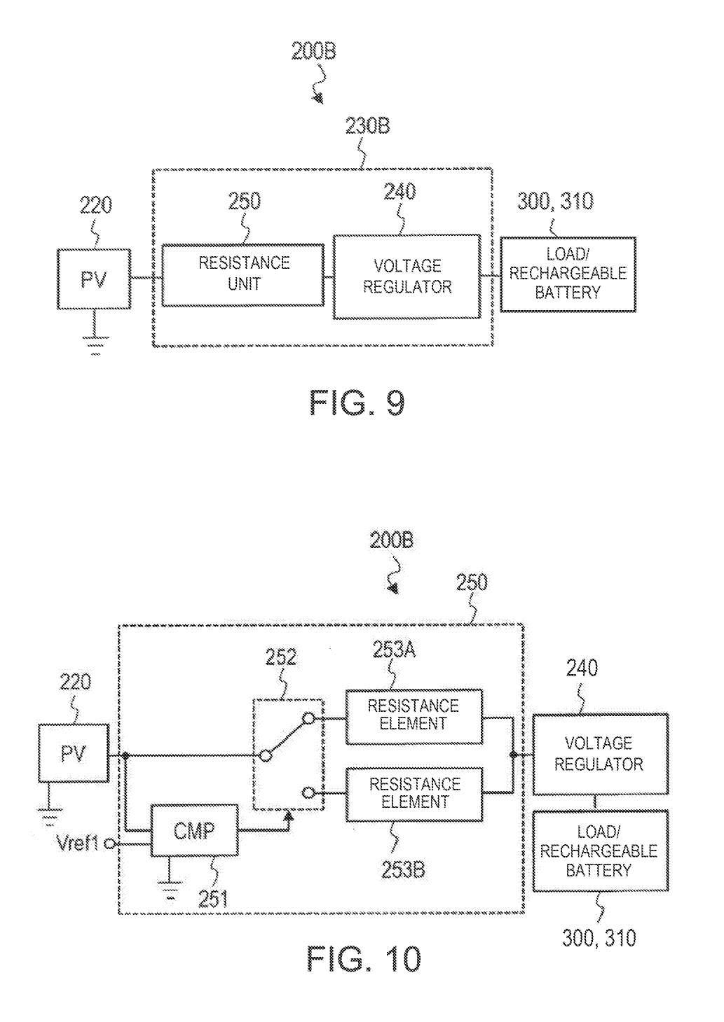

A structure and functions of a mobile electronic device casing 200B according to a second embodiment are described with reference to FIGS. 9 and 10.

The mobile electronic device casing 200B of the second embodiment is different from the mobile electronic device casing 200A of the first embodiment in that a power supply unit 230B also includes a resistance unit 250. Hereinafter, descriptions of common components of the casings 200A and 200B are omitted, and components different therebetween are mainly described.

FIG. 9 schematically illustrates a circuit configuration of the mobile electronic device casing 200B. The power supply unit 230B includes a voltage regulator 240 and the resistance unit 250. The resistance unit 250 has a variable resistance value. The resistance unit 250 has a function to adjust an output impedance of the solar cell module 220. The resistance unit 250 has a plurality of resistance elements having different resistance values from each other, and selects one of the plurality of resistance elements according to the output voltage of the solar cell module 220. Thus, the solar cell module 220 is connected with the voltage regulator 240 via the selected resistance element.

FIG. 10 schematically illustrates a circuit configuration of the resistance unit 250. The resistance unit 250 includes a comparator (CMP) 251, a switch 252, and resistance elements 253A and 253B. These components may be integrated on a single substrate to achieve the resistance unit 250 as an integrated circuit.

The resistance elements 253A and 253B have different resistance values from each other. Specifically, the resistance value of the resistance element 253A is higher than that of the resistance element 253B. For example, when a largest output power of the solar cell module 220 is 10 W or less, the resistance value of the resistance element 253A may be set to 30 kΩ and the resistance value of the resistance element 253B may be set to 0.1 kΩ.

The comparator 251, in response to receiving the output voltage of the solar cell module 220, compares and determines the output voltage with a first reference voltage Vref1. Here, the first reference voltage Vref1 may suitably be determined based on the characteristics of the solar cell module 220 and the MPPT circuit 241, etc. For example, the first reference voltage Vref1 can be set to about 0.8 V.

The switch 252 is a relay switch, for example. The switch 252 switches the circuit connection between the resistance element 253A and the resistance element 253B according to the comparison result of the comparator 251. When the resistance element 253A is selected, the solar cell module 220 is connected with the voltage regulator 240 via the resistance element 253A. When the resistance element 253B is selected, the solar cell module 220 is connected with the voltage regulator 240 via the resistance element 253B. Hereinafter, the operation of the switch is described in detail.

The comparator 251 turns on and off a current which controls the switch 252, according to the comparison result between the output voltage of the solar cell module 220 and the first reference voltage Vref1. When the output voltage of the solar cell module 220 is the first reference voltage Vref1 or more, the comparator 251 turns on the control current to cause the switch 252 to select the resistance element 253A. Thus, in a case where the illuminance is comparatively high (e.g., sunny weather), the resistance unit 250 has the resistance value corresponding to the resistance element 253A.

When the output voltage of the solar cell module 220 is less than the first reference voltage Vref1, the comparator 251 turns off the control current to cause the switch 252 to select the resistance element 253B. Thus, in a case where the illuminance is comparatively low (e.g., cloudy weather), the resistance unit 250 has the resistance value corresponding to the resistance element 253B.

In other words, in the case where the illuminance is comparatively high (e.g., sunny weather), the solar cell module 220 is connected with the voltage regulator 240 via the resistance element 253A, and in the case where the illuminance is comparatively low (e.g., cloudy weather), the solar cell module 220 is connected with the voltage regulator 240 via the resistance element 253B having the smaller resistance value than that of the resistance element 253A. Thus, the resistance unit 250 has a high resistance value when the illuminance is high, and has a low resistance value when the illuminance is low.

When the illuminance is low, the output voltage, the current, and the power of the solar cell module 220 are low. Therefore, if the resistance value is set to be high, the input voltage to the voltage regulator 240 becomes low and a change in the output detected by the MPPT circuit 241 becomes smaller. As a result, the operation accuracy of the MPPT circuit 241 degrades. In this embodiment, when the illuminance is low, the resistance value is set to be low, and therefore, such a situation can be avoided and power can efficiently be supplied to the MPPT circuit 241.

On the other hand, when the illuminance is high, the output voltage, the current, and the power of the solar cell module 220 are comparatively high. Therefore, if the resistance value is set to be low, the power cannot efficiently be supplied to the voltage regulator 240. Further, the input voltage to the MPPT circuit 241 may shift from the optimal operating point. In this embodiment, when the illuminance is high, the resistance value is set to be high, and therefore, such situations can be avoided.

Note that the mobile electronic device casing 200B may further be provided with an illuminance sensor (not illustrated) connected with the comparator 251. Any of various known sensors may broadly be used as the illuminance sensor. The illuminance sensor detects an illuminance of light to be irradiated to the solar cell module 220. The illuminance sensor generates a current according to the detection result, and outputs it to the comparator 251. The comparator 251 compares the current value from the illuminance sensor with a reference current Iref to determine which is larger. For example, the reference current Iref may be 1 mA.

When the current value from the illuminance sensor is the reference current Iref or more, the switch 252 selects the resistance element 253A, and when the current value from the illuminance sensor is less than the reference current Iref, the switch 252 selects the resistance element 253B. As described above, the resistance unit 250 can also select one of the two resistance elements according to the illuminance signal, which may be a current value, from the illuminance sensor.

According to this embodiment, the power of the solar cell module 220 can efficiently be supplied to one of the load 300 and the rechargeable battery 310 over a wide range from low to high illuminances. For example, the mobile electronic device 300 can be charged while being controlled, or it can be charged in the shade of an outdoor tree. An illuminance range for the charging while controlling can be assumed to be from approximately 0.2 mW/cm² to approximately 0.5 mW/cm², and an illuminance range for the charging in the shade of a tree can be assumed to be from approximately 10 mW/cm² to approximately 50 mW/cm². Further, by also feeding the power via the MPPT circuit 241 when the illuminance is low, the charging efficiency of the rechargeable battery 310 can be improved. Furthermore, by combining the power supply unit 230B with the low-illuminance-supported solar cell module, efficient power generation can be performed over an even wider illuminance range.

### Third Embodiment

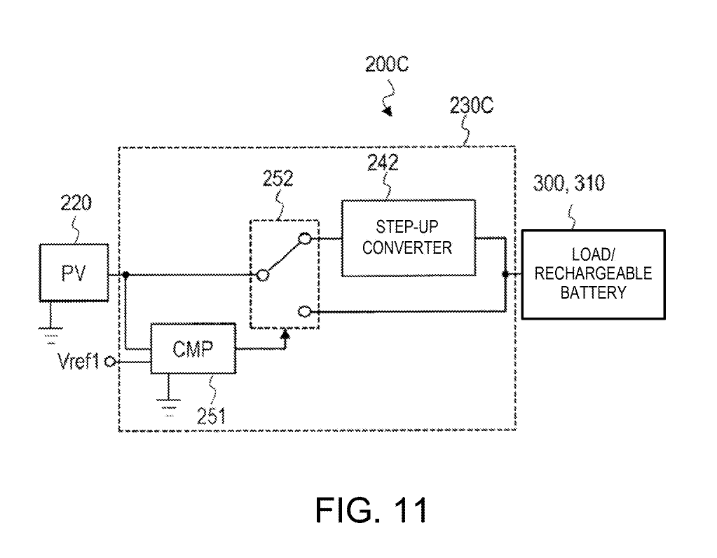

A structure and functions of a mobile electronic device casing 200C according to a third embodiment are described with reference to FIG. 11.

The mobile electronic device casing 200C of the third embodiment is different from the mobile electronic device casing 200A of the first embodiment in that a power supply unit 230C is switchable of the circuit connection between a first power supply path and a second power supply path where a step-up converter 242 is provided. Hereinafter, descriptions of common components of the casings 200A and 200C are omitted, and components different therebetween are mainly described.

FIG. 11 schematically illustrates a circuit configuration of the mobile electronic device casing 200C. The power supply unit 230C includes a comparator 251, a switch 252, and the step-up converter 242.

The switch 252 switches the circuit connection between the first power supply path where nothing is disposed, and the second power supply path where the step-up converter 242 is provided, according to the comparison result of the comparator 251. The switch 252 selects the first power supply path when the illuminance is a reference value or more, and selects the second power supply path when the illuminance is below the reference value.

According to this embodiment, when an illuminance above a predetermined value is obtained and the output voltage is sufficiently high, the power can directly be supplied to one of the load 300 and the rechargeable battery 310 without passing through the step-up converter 242. As a result, a power loss caused by power consumption at the step-up converter 242 can be eliminated and the power of the solar cell module 220 can effectively be utilized.

### Fourth Embodiment

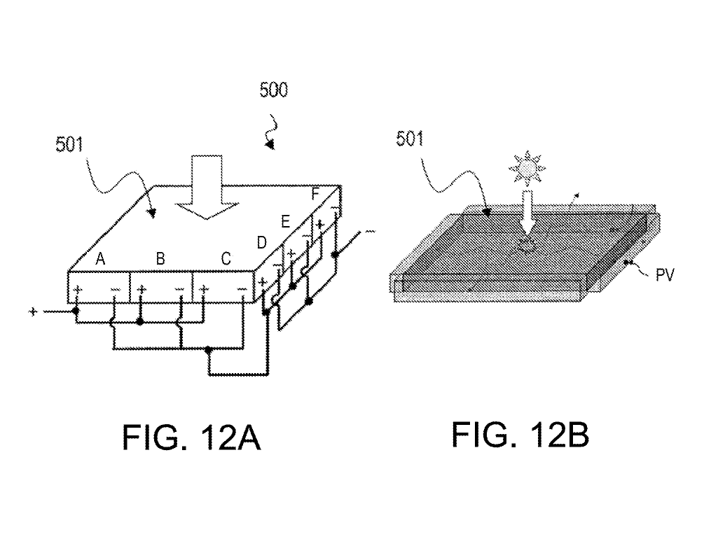

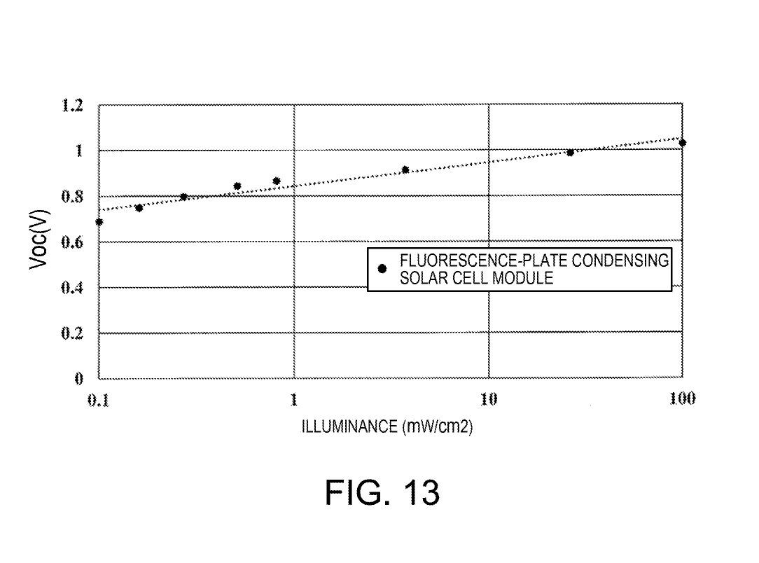

A structure and functions of a mobile electronic device casing 200D according to a fourth embodiment are described with reference to FIGS. 12 and 13.

The mobile electronic device casing 200D (not illustrated) of the fourth embodiment is different from the mobile electronic device casings 200A, 200B, and 200C of the first to third embodiments in that a solar cell module using a fluorescence condensing plate (hereinafter, referred to as “the fluorescence-plate condensing solar cell module”) 500 is provided as the low-illuminance-supported solar cell module. Hereinafter, descriptions of common components with the casings 200A, 200B, and 200C are omitted, and components different thereamong are mainly described.

FIGS. 12A and 12B schematically illustrate a structure of the fluorescence-plate condensing solar cell module 500. GaAs solar cell modules A to F are disposed at side surfaces of a fluorescence plate 501. When light enters into the fluorescence plate 501, the light is absorbed by a fluorescent material within the fluorescence plate 501, causing light emission. Due to the principle of total internal reflection, a substantial part of the light is trapped inside the fluorescence plate 501 and is condensed in the respective GaAs solar cell modules A to F disposed at the side surfaces of the fluorescence plate 501. Due to this principle, light absorbed by the fluorescence plate 501 having a larger area than a total area of the GaAs solar cell modules A to F can be condensed in the respective GaAs solar cell modules A to F having smaller areas. As a result, highly efficient power generation can be achieved in each of the GaAs solar cell modules. Furthermore, when the fluorescence plate 501 is irradiated by sunlight, the sunlight is changed in color by the fluorescence plate 501 and then condensed in the GaAs solar cell modules A to F. Therefore, when a red fluorescence plate is used for example, light of about 650 nm is condensed in the GaAs solar cell modules A to F. Thus, light close to an energy gap of a solar cell can efficiently enter into each GaAs solar cell module.

Each GaAs solar cell module has a characteristic that a reduction amount of the output voltage is small even when the illuminance decreases. With the fluorescence-plate condensing solar cell module 500, by condensing light with the fluorescence plate 501, the amount of light which enters into the fluorescence-plate condensing solar cell module 500 becomes a few times larger. Therefore, a voltage reduction amount of the fluorescence-plate condensing solar cell module 500 that is caused by an illuminance change is particularly small.

FIG. 13 illustrates an illuminance dependency of an output voltage (open-circuit voltage) of the fluorescence-plate condensing solar cell module 500. Under a measurement condition defined by the standard MS C 8914, in terms of a relationship between the illuminance and the open-circuit voltage, when the illuminance changes from 100 mW/cm² to 1 mW/cm², a largest output voltage (open-circuit voltage) varies from 1.02 V to 0.84 V per unit cell. In other words, a variation amount AV per unit cell is improved to 0.18 V compared to the p-Si module and the DSC module illustrated in FIG. 1.

Further, the fluorescence-plate condensing solar cell module 500 has a characteristic that when the illuminance decreases from 100 mW/cm² to 1 mW/cm², the reduction amount of the open-circuit voltage is 0.2 V or less. Further, when the illuminance is 1 mW/cm², the open-circuit voltage is 0.8 V or more, which is extremely high. Therefore, it can be said that the fluorescence-plate condensing solar cell module 500 is also a low-illuminance-supported solar cell module.

According to this embodiment, the power of the solar cell module 220 can efficiently be supplied to one of the load 300 and the rechargeable battery 310 over a wide range from low to high illuminances. For example, the mobile electronic device 300 can be charged while being controlled, or it can be charged in the shade of an outdoor tree. When the illuminance is even higher, efficient power generation can still be performed.

### Fifth Embodiment

In each of the first to fourth embodiments described above, the charger is described as the mobile electronic device casing including the low-illuminance-supported solar cell module. However, the present invention is not limited to this and the mobile electronic device 300 itself may include the low-illuminance-supported solar cell module. In this case, the low-illuminance-supported solar cell module may be disposed at a back surface of a housing of the mobile electronic device, which is on an opposite side from the display screen surface 300A. With this configuration, even in an environment that a light receiving surface of the module is not irradiated by direct light and the illuminance is significantly low, the charging can be performed effectively while using the mobile electronic device 300. Further, the power generation can be performed efficiently even when the illuminance is high.

Moreover, the mobile electronic device 300 preferably includes a voltage regulator 240 as well. Thus, even when the illuminance decreases and the output voltage of the solar cell module 220 is dramatically varied, the power of the solar cell module 220 can stably be supplied to the rechargeable battery inside the device.

The present specification discloses mobile electronic device casings and mobile electronic devices described in the following items.

(Item 1)

A mobile electronic device casing for accommodating a mobile electronic device having a display screen surface, and supplying power to the mobile electronic device, is provided. The mobile electronic device casing includes a solar cell module comprised of one or more cells and having a characteristic that in a case where a relationship between an illuminance and an open-circuit voltage is measured by using a solar simulator under a condition that an air mass is 1.5, a temperature of the solar cell module is 25° C., and a light incident direction is perpendicular to a light receiving surface of the cell, when the illuminance is decreased from 100 mW/cm² to 1 mW/cm², a reduction amount of the open-circuit voltage is 0.2 V or less, and when the illuminance is 1 mW/cm², the open-circuit voltage is 0.55 V or more. The solar cell module is located on an opposite side from the display screen surface and exposed to an outside of the mobile electronic device casing when the mobile electronic device is used in the accommodated state. According to the mobile electronic device casing described in Item 1, the mobile electronic device casing which can efficiently generate power while controlling the mobile electronic device even when the illuminance is decreased and the output voltage of the solar cell module is reduced, can be provided.

(Item 2)

In the mobile electronic device casing described in Item 1, the solar cell module has a structure in which the cells are electrically-linearly connected with each other and the cells are integrated on a single substrate. According to the mobile electronic device casing described in Item 2, the solar cell module can become highly dense.

(Item 3)

The mobile electronic device casing described in Item 2 further includes a power supply unit for supplying the power from the solar cell module to a load. The power supply unit includes a voltage regulator having one of a step-up converter and a step-down converter. According to the mobile electronic device casing described in Item 3, a power loss caused when supplying the power from the solar cell module to the load can be eliminated.

(Item 4)

In the mobile electronic device casing described in Item 3, the voltage regulator also includes a control circuit for performing a control of tracking an optimal operating point of the solar cell module. According to the mobile electronic device casing described in Item 4, even when the illuminance and/or a temperature change, the solar cell module can generate power at the optimal operating point under a corresponding circumstance, and the greatest power possible in that circumstance can be obtained.

(Item 5)

In the mobile electronic device casing described in Items 3 or 4, the power supply unit also includes a resistance unit provided between the solar cell module and the voltage regulator and having a variable resistance value. According to the mobile electronic device casing described in Item 5, the power of the solar cell module can efficiently be supplied to the load over a wide range from low to high illuminances.

(Item 6)

In the mobile electronic device casing described in Item 5, the resistance unit includes a plurality of resistance elements having different resistance values from each other and selects one of the plurality of resistance elements according to the output voltage of the solar cell module, and the solar cell module is connected with the voltage regulator via the selected resistance element. According to the mobile electronic device casing described in Item 6, since a suitable resistance element corresponding to the illuminance is selected, even when the illuminance changes and the output voltage of the solar cell module is varied, the power of the solar cell module can efficiently be supplied to the load.

(Item 7)

In the mobile electronic device casing described in any one of Items 1 to 6, the solar cell module is one of a dye-sensitized solar cell module and a solar cell module using a fluorescence condensing plate. According to the mobile electronic device casing described in Item 7, the mobile electronic device casing which is provided with a low-illuminance-supported solar cell module of which a reduction amount of the open-circuit voltage is small even when the illuminance decreases, can be provided.

(Item 8)

The mobile electronic device casing described in any one of Items 3 to 7 also includes a rechargeable battery connected with the power supply unit and for storing the power from the solar cell module. According to the mobile electronic device casing described in Item 8, the mobile electronic device casing which is provided with the rechargeable battery for efficiently storing the power from the solar cell module, can be provided.

(Item 9)

A mobile electronic device is provided. The mobile electronic device includes a housing having a display screen surface, and a solar cell module comprised of one or more cells, disposed on an opposite side from the display screen surface, and having a characteristic that in a case where a relationship between an illuminance and an open-circuit voltage is measured by using a solar simulator under a condition that an air mass is 1.5, a temperature of the solar cell module is 25° C., and a light incident direction is perpendicular to a light receiving surface of the cell, when the illuminance is decreased from 100 mW/cm² to 1 mW/cm², a reduction amount of the open-circuit voltage is 0.2 V or less, and when the illuminance is 1 mW/cm², the open-circuit voltage is 0.55 V or more. According to the mobile electronic device described in Item 9, the mobile electronic device which can efficiently generate power while controlling the mobile electronic device even when the illuminance is decreased and the output voltage of the solar cell module is reduced, can be provided.

The present invention can be utilized for mobile electronic device casings and mobile electronic devices, provided with a solar cell module.

### LIST OF REFERENCE CHARACTERS

12, 32 Substrate

14 Transparent Conductive Layer

34 Antipole

15 Photoanode

16 Metallic Oxide Layer

18a Porous Semiconductor Layer

42 Photoelectric Conversion Layer

100, 100a Electrolytic Medium

100, 100a DSC

200A, 200B, 200C Mobile Electronic Device Casing

210 Holder Part

220 Solar Cell Module

230A, 230B, 230C Power Supply Unit

240 Voltage Regulator

241 MPPT Circuit

242 Step-up Converter

243 Step-down Converter

250 Resistance Unit

251 Comparator

252 Switch

253A, 253B Resistance Element

300 Mobile Electronic Device (Load)

310 Rechargeable Battery

300A Display Screen Surface

400 DSC Module

500 Fluorescence-plate Condensing Solar Cell Module

What is claimed is:

1. A mobile electronic device casing for accommodating a mobile electronic device having a display screen surface, and supplying power to the mobile electronic device, the mobile electronic device casing comprising:
a solar cell module comprised of one or more cells and having a characteristic that in a case where a relationship between an illuminance and an open-circuit voltage is measured by using a solar simulator under a condition that an air mass is 1.5, a temperature of the solar cell module is 25° C., and a light incident direction is perpendicular to a light receiving surface of the cell, when the illuminance is decreased from 100 mW/cm² to 1 mW/cm², a reduction amount of the open-circuit voltage is 0.2 V or less, and when the illuminance is 1 mW/cm², the open-circuit voltage is 0.55 V or more,
wherein the solar cell module is located on an opposite side from the display screen surface and exposed to an outside of the mobile electronic device casing when the mobile electronic device is used in the accommodated state.

2. The mobile electronic device casing of claim 1, wherein the solar cell module has a structure in which the cells are electrically-linearly connected with each other and the cells are integrated on a single substrate.

3. The mobile electronic device casing of claim 2, further comprising a power supply unit for supplying the power from the solar cell module to a load,
wherein the power supply unit includes a voltage regulator having one of a step-up converter and a step-down converter.

4. The mobile electronic device casing of claim 3, wherein the voltage regulator further includes a control circuit for performing a control of tracking an optimal operating point of the solar cell module.

5. The mobile electronic device casing of claim 1, wherein the solar cell module is one of a dye-sensitized solar cell module and a solar cell module using a fluorescence condensing plate.
